(19) United States
(12) Patent Application Publication
(10) Pub. No.: US 2014/0165112 A1
(43) Pub. Date: Jun. 12, 2014

(54) LAUNCHING A SECOND-SCREEN APPLICATION RELATED TO A NON-TRIGGERED FIRST-SCREEN APPLICATION

(71) Applicant: SAMSUNG ELECTRONICS COMPANY, LTD., Suwon (KR)

(72) Inventors: Martin Freeman, Palo Alto, CA (US); William Foote, Irvine, CA (US)

(73) Assignee: SAMSUNG ELECTRONICS COMPANY, LTD., Suwon (KR)

(21) Appl. No.: 14/023,215

(22) Filed: Sep. 10, 2013

Related U.S. Application Data
(60) Provisional application No. 61/735,885, filed on Dec. 11, 2012.

(51) Int. Cl. H04N 21/436; H04N 21/47; H04N 21/27; H04N 21/214; H04N 21/41

(52) U.S. Cl. CPC H04N 21/43615; H04N 21/2143; H04N 21/4126; H04N 21/27; H04N 21/47
USPC 725/81

(57) ABSTRACT

A method for application launching for electronic devices comprises executing a first application on a first electronic device based on a non-triggered input. Information is received on a second electronic device from the first electronic device. A second application is launched on the second electronic device based on the received information.

### CROSS-REFERENCE TO RELATED APPLICATIONS

This application claims the priority benefit of U.S. Provisional Patent Application Ser. No. 61/735,885, filed Dec. 11, 2012, incorporated herein by reference in its entirety.

### TECHNICAL FIELD

One or more embodiments relate generally to applications in a network environment, and in particular to launching a second-screen application related to a first-screen application.

### BACKGROUND

Television has been paired with interactive elements to provide a more immersive interactive experience. “One-screen” interactivity consists of HyperText Markup Language (HTML) pages or other application types that are presented on the main television screen. “Two-screen” interactivity pairs HTML pages or other application types executing on a second device with whatever is being shown on the primary television device.

### SUMMARY

In one embodiment, a method provides for application launching for electronic devices. One embodiment comprises executing a first application on a first electronic device based on a non-triggered input. In one embodiment, information is received on a second electronic device from the first electronic device. In one embodiment, a second application is launched on the second electronic device based on the received information.

Another embodiment provides a system for application launching for electronic devices. One embodiment comprises a first electronic device that executes a first application based on a non-triggered event. In one embodiment, a second electronic device obtains information related to the first application, and executes a second application based on the obtained information.

Another embodiment provides a computer program product for application launching for electronic devices. The computer program product comprising: a tangible storages medium readable by a computer system and storing instructions for execution by the computer system for performing a method comprising: executing a first application on a first electronic device based on a non-triggered input. In one embodiment, information is received on a second electronic device from the first electronic device. In one embodiment, a second application is launched on the second electronic device based on the received information.

One embodiment provides a method for application launching for electronic devices. In one embodiment, the method comprises executing a first application on a first electronic device based on a non-triggered input. In one embodiment, the first application launches a second application on a second electronic device. In one embodiment, the second application is related to content provided on the first electronic device.

These and other aspects and advantages of one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the one or more embodiments, as well as a preferred mode of use, reference should be made to the following detailed description read in conjunction with the accompanying drawings, in which:

FIG. 1 shows a block diagram of a system architecture for application launching, according to an embodiment.

FIG. 2 shows a block diagram of a network system for application launching, according to an embodiment.

FIG. 3 shows an example scenario for application launching in a network, according to an embodiment.

FIG. 4 shows an example flow chart for application launching, according to an embodiment.

FIG. 5 shows an example flow chart for a first screen device application launching, according to an embodiment.

FIG. 6 shows an example flow chart for a first screen device application server, according to an embodiment.

FIG. 7 shows a block diagram for an example architecture for a first screen device, according to an embodiment.

FIG. 8 shows an example flow chart for a second screen device application launcher, according to an embodiment.

FIG. 9 shows a block diagram for an example architecture for a second screen device, according to an embodiment.

FIG. 10 is a high-level block diagram showing an information processing system comprising a computing system implementing an embodiment.

### DETAILED DESCRIPTION

The following description is made for the purpose of illustrating the general principles of the one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to application launching. One embodiment provides launching a second-screen application based on information related to a first-screen application within a network by electronic devices.

In one embodiment, the electronic devices comprise one or more mobile electronic devices capable of data communication over a communication link such as a wireless communication link. Examples of such mobile device include a mobile phone device, a mobile tablet device, etc. In one embodiment, a method provides for application launching for electronic devices. One embodiment comprises executing a first application on a first electronic device based on an input that is not a trigger (e.g., menu selection of an application, etc.). Broadcast systems may contain “triggers,” which are small data messages that are sent in a broadcast stream, either loosely or tightly synchronized in time to other broadcast elements, such as audio or video content. The data payload of triggers may be used to launch or control applications, or may be interpreted by applications to take some action. A “triggered” application is one that is launched as a result of a trigger, and a “non-triggered” application is one that is launched by other means. The information is received on a second electronic device from the first electronic device. In one embodiment, a second application is launched on the second electronic device based on the received information.

One or more embodiments relate to a new service provided by an AppURL server that facilitates the launching of a second screen application on a second screen device. In one or more embodiments, when the first screen application executes on the first screen device and the second screen application executes on the second screen device, a non-standard, private communication may take place. In one embodiment, after the first screen application is launched on the first screen device, the first screen application executes a setURL command, which notifies the AppURL server on the first screen device of the name and the URL of the second screen application. The name is used to identify the second screen application that is associated with the executing first screen application, while the URL identifies where the second screen application code may be found. In one or more embodiments, the AppURL server then makes the name and the URL of the second screen application available to devices on the home network via two different means: announcement and discovery.

In one embodiment, the announcement occurs after receiving the setURL command. The AppURL server issues a UPnP event on the home network. In one embodiment, this event is a message containing the name and URL of the second screen application. If there is an AppLauncher application executing on the second screen device, then the AppLauncher will receive and process the UPnP event and cause a notification to be displayed on the screen of the second screen device indicating that a companion application of an already executing first screen application executing on a first screen device is available for executing. In one embodiment, if the user decides to accept running the second screen application, then the AppLauncher launches the second screen application on the second screen device. In one or more embodiment, the first screen and second screen applications may then communicate with one another. However, if an AppLauncher starts execution after the UPnP event, then that AppLauncher may (under user control) discover the AppURL server executing on a first screen device, and then query the name and URL of the associated second screen application. The user is notified and may choose to have the AppLauncher launch the second screen application.

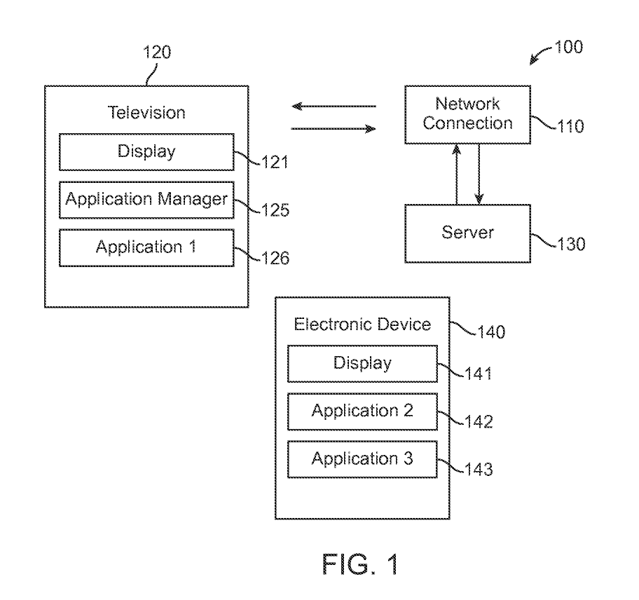

FIG. 1 shows a functional block diagram of an embodiment of a system 100 for application launching in a network on an electronic device 140, according to an embodiment. In one embodiment, the system 100 comprises a television device 120, a server device 130 and network connection device 110. In one embodiment, the television device 120 comprises a display 121, and an application manager module 125 for managing applications, such as application 1 126.

In one embodiment, the display 121 may be a separate device from the television device 120 or integrated with the television device 120. In one embodiment, the network connection device 110 may comprise a network interface, such as a network modem, router, etc. for handling communications between the television device 120 and the server device 130 and for forming a local network that the television device 120 may be connected with.

In one embodiment, the electronic devices 140 may comprise mobile devices that may utilize mobile device hardware functionality including: a display 141, a camera module including one or more a cameras, a global positioning satellite (GPS) receiver module, a compass module, and an accelerometer and gyroscope module. The camera module is used to capture images of surroundings. The GPS module is used to identify a current location of the mobile device (i.e., user). The compass module is used to identify direction of the mobile device. The accelerometer and gyroscope module is used to identify tilt of the mobile device.

The system 100 provides the electronic device 140 the ability to launch a second application, such as application 2 142 for providing content on the display 141, which is launched based on information from a first application, such as application 1 126 executing on the television device 120. Interactive services may be implemented using different application types. One type of application is called a “declarative object (DO),” which is based, in part, on declarative HTML technologies. In one embodiment, the application 1 126 may comprise a non-triggered application, e.g. a non-triggered declarative object (DO) type application that executes on the television device 120 and display content on the display 121. In one embodiment, the application 1 126 may be launched based on a user selecting the application from a menu on the display 121, from a remote control device, by voice commands, etc.

In one embodiment, the local network (e.g., a wireless network) that the television device 120 is connected to is a secured network with a security code (e.g., pass code, password, key code, etc.) providing access to the local network such that without having knowledge of the key code, the electronic device 140 cannot pair or join the local network. In one embodiment, access is provided to the electronic device 140 to the local network that the application is launched using a security code. In one embodiment, the security code is unique for each session. In other embodiments, the local network may be unsecured or based on distance to the network connection device 110.

In one embodiment, the application 1 126 comprises a non-triggered software application, a non-triggered DO, or similar application that is provided by a broadcaster (e.g., a television broadcaster, content broadcaster, etc.) at some earlier time, and stored in persistent memory on the television device 120. In one embodiment, the application 1 126 may be launched by a user at a later time, e.g. by selecting from a menu, via a remote control, voice commands, etc. In one embodiment, the application 1 126 is a broadcaster-provided application that was previously downloaded.

In one embodiment, the application 1 126 is a first-screen application that is downloaded and permanently stored on television device 120, and started by the user, and not by any broadcaster triggers (i.e., application 1 126 is not executed based on a current broadcast, a current channel, etc.). In one embodiment, the location of the application 2 142, which comprises a second-screen application, is published by the television device 120 (e.g., over a local area network). In one embodiment, the application 2 142 is launched on the electronic device 140. In one embodiment, the application 2 142 is not limited to being the user interface of the application 1 126, and may or may not be responsive to triggers.

In one embodiment, advantages of non-triggered first-screen applications (e.g., application 1 126) over triggered first-screen applications are as follows. Triggered applications may be pre-empted by triggered applications of higher priority, thus the user experience on the second-screen device (e.g., electronic device 140) may suffer through application transitions on the first-screen device (e.g., television device 120). In one embodiment, a non-triggered application executing on the first-screen device provides application persistence (i.e., not subject to pre-emption by higher priority applications). Triggered applications are associated with the current broadcaster station being tuned to, whereas in one embodiment, a non-triggered application (e.g., application 1 126) may have been previously downloaded from a server of another broadcaster. In one embodiment, non-triggered applications may execute regardless of the broadcaster station being tuned to. In one embodiment, non-triggered applications running on the television device 120 may interact with either non-triggered or triggered applications (e.g., application 2 142) running on the second-screen device (e.g., electronic device 140). In one embodiment, a second-screen application related to the content being played from a content server may be launched by another application (e.g., external content application) as the second screen application on the second-screen device (e.g., electronic device 140).

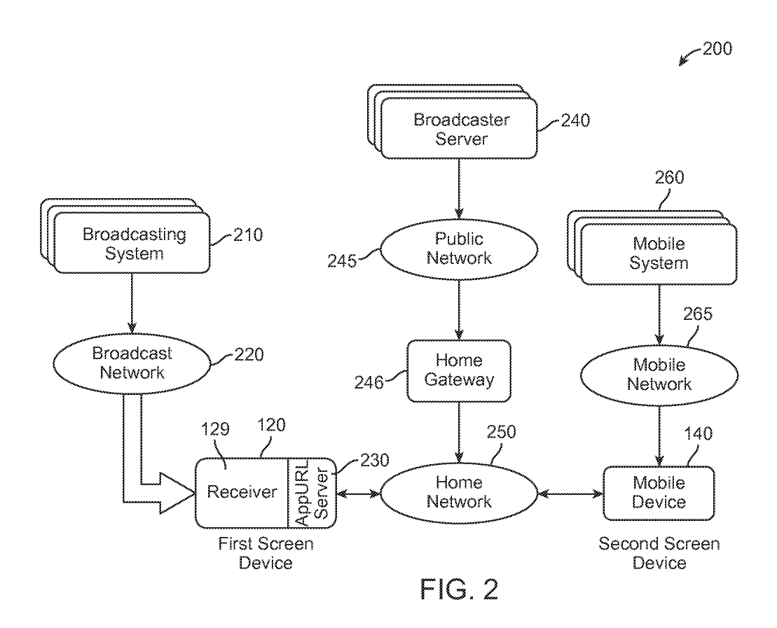

FIG. 2 shows a block diagram of a network system 200 for application launching, according to an embodiment. In one embodiment, the network system 200 comprises a broadcasting system 210 (e.g., television broadcast system, content broadcasting system, etc.), broadcast network 220, television device 120, broadcaster server 240, public network 245 (e.g., Internet), local gateway 246 (e.g., a home gateway), local network 250 (e.g., a home network), mobile system 260, mobile network 265 and electronic device 140. In one embodiment, a broadcaster-provided packaged app (e.g., application 1 126) that was previously downloaded to the television device 120 to launch a second-screen application (e.g., application 2 142) on a second-screen device (e.g., electronic device 140), such as a smart phone, a tablet, a wearable device, a laptop computer, etc.

In one embodiment, an application (e.g., application 3 143) playing the role of “launcher” is running on the second-screen device (e.g., electronic device 140), and listening for notifications of information or polling for information in order to launch a second-screen application (e.g., application 2 142). In one embodiment, there is no expectation that the author of the broadcaster's application (e.g., provided by broadcaster server 240, provided by a content provider server, etc.) and the launcher application (e.g., application 3 143) were authored by the same party or by parties that are forced to coordinate. In one embodiment, all communications occur via standardized protocols to ensure interoperability. In one embodiment, the local network 250 comprises of a wired or wireless (e.g., Wi-Fi) network based on the TCP/IP protocol.

In one embodiment, the television device 120 includes a receiver 129 (e.g., an advanced television systems committee (ATSC) 2.0 receiver, or similar receiver, etc.) for receiving broadcast content (e.g., via television, cable, satellite, etc.) and a service or server process 230. In one embodiment, the service 230 comprises a universal plug and play (UPnP) service referred to as a “AppURL Server,” with service type “atsc2.0urls.1” and Service ID “urn.atsc.org.serviceID:atsc2.0urls1.” In one embodiment, the service 230 allows second-screen devices to be notified when a first-screen application (e.g., application 1 126, a non-triggered application, DO, etc.) executing on the television device 120 makes available the uniform resource locator (URL) of a second-screen application (e.g., an associated or companion application), such as application 2 142, that is linked to the first-screen application.

In one embodiment, the service 230 has two state variables referred to as “AppURL” and “AppName.” In one embodiment, the value of AppURL is the base URL of the second-screen application associated with the currently executing first-screen application or DO, while the value of AppName is the name of the second-screen application associated with the currently executing first-screen application or DO. In one embodiment, when there is no executing first-screen application or DO, or when the currently executing first-screen application or DO has no associated second-screen application, the value of these state variables is each the null string. In one embodiment, the service 230 has a single action, called “GetAppURL,” with two arguments referred to as “AppURL” and “AppName.” In one embodiment, the AppURL argument is the current value of the AppURL state variable, while the AppName argument is the current value of the AppName state variable. In one embodiment, the service 230 permits both polling by and notification to the launcher application, such as application 3 143. In one example embodiment, when a launcher application is first started, it may first poll the state variables of service 230, and if the values are null, it may then subscribe to notifications.

In one embodiment, the second-screen application (e.g., application 2 142) launched on the electronic device 140 may be either a non-triggered or a triggered application. In one embodiment, a triggered application would have a life cycle controlled by the broadcasting system 210. In one embodiment, a non-triggered first-screen application (e.g., application 1 126) in conjunction with a triggered second-screen application (e.g., application 2 142) would have its greatest value when the application executing on the first-screen device was downloaded from the broadcaster server 240 whose station broadcasted from the broadcast network 220 is currently being tuned by the receiver 120. In this scenario, in one embodiment the second-screen application may execute without concern about first-screen application persistence.

In one embodiment, the values of the AppURL and AppName state variables are set with an application programming interface (API) call defined in the execution environment (e.g., television device 120) that hosts the DO (e.g., application 1 126). In one embodiment, the API call is defined on a class referred to as PublishURL. In one embodiment, the API method employed is referred to as setAppURL( ) and takes two string arguments: “url,” containing the base URL of the second-screen application (e.g., application 2 142) associated with the currently executing DO (e.g., application 1 126, and “name,” containing the name of the second-screen application (e.g., application 2 142) associated with the currently executing DO (e.g., application 1 126).

In one embodiment, the public network comprises a network such as the Internet, and the local gateway 246 may comprise a modem or similar device. In one embodiment, the mobile system comprises the infrastructure used by carriers to form the mobile network 265 for communications with the electronic device 140.

In one embodiment, the local network 250 may utilize a protocol such as Bluetooth. In one embodiment, other protocols similar to UPnP may be used by system 200. In one embodiment, the first-screen application execution environments may be environments other than ATSC 2.0, for example, in Europe the receiver 129 may comprise a hybrid broadcast broadband television (HbbTV) receiver.

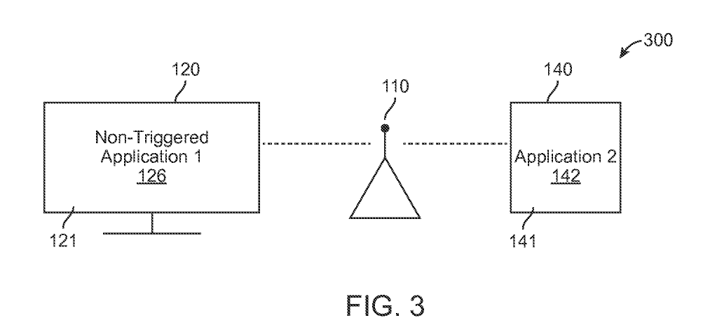

FIG. 3 shows an example scenario 300 for application launching in a network, according to an embodiment. In one embodiment, a first-screen (non-triggered) application 1 126 is launched on a television device 120 and starts up, such as by selecting an application on the display 121 of the television device 120 by using a device such as a remote control, pointing device, voice command, using an application executing on a smart phone or tablet device, etc. In one embodiment, the first-screen (non-triggered) application 1 126 is launched in a local network (e.g., a home network).

In one embodiment, network information from the television device 120 may be discovered by the electronic device 140, where the network information may comprise a wireless network service set identification (SSID), network key, television device internet protocol (IP) address, etc. In one embodiment, the electronic device 140 joins the local network based on the network information.

In one embodiment, the network connection 110 provides signals for the television device 120 to connect with a local network, either wirelessly (e.g., WIFI) or wired (e.g., via Ethernet). In one embodiment, information (e.g. state variables from the service 230: AppURL and AppName), from the application 1 126 is communicated over the local network to the electronic device 140, where a launcher application (e.g., application 3 143) obtains the information. In one embodiment, based on the obtained information, a second-screen application 2 142 is launched and content from the application 2 142 is displayed on display device 141.

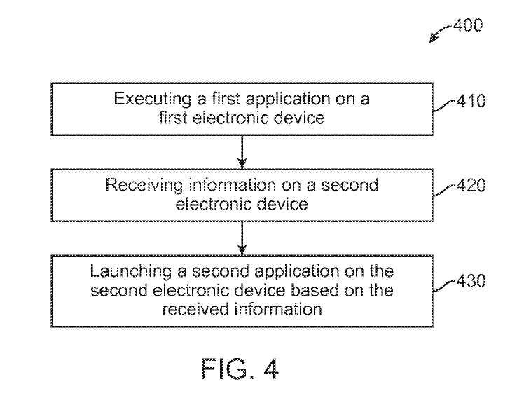

FIG. 4 shows an example flow chart 400 for application launching, according to an embodiment. In one embodiment, in block 410 the process 400 executes a first application (e.g., application 1 126, FIG. 1) on a first electronic device (e.g., television device 120) based on a non-triggered input (e.g., based on user input, user commands, a remote control action, etc.). In one embodiment, in block 420 information (e.g. state variables from the service 230 (FIG. 2): AppURL and AppName) on a second electronic device (e.g., electronic device 140) is received from the first electronic device. In one embodiment, in block 430, a second application (e.g., application 2 142) is launched/executed on the second electronic device based on the received information.

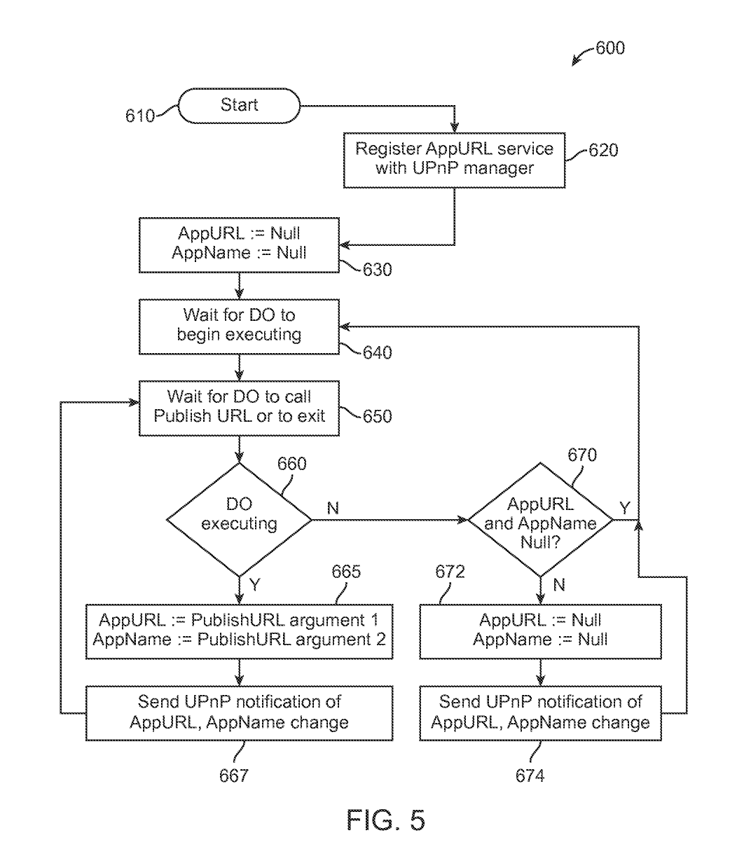

FIG. 5 shows an example flow chart 600 for a first screen device (e.g., television device 120) application launching, according to an embodiment. In one embodiment, in block 610 the flowchart starts based on the first screen device being turned on or the operating system being rebooted. In one embodiment, in block 620, the AppURL Service is registered with the first screen device UPnP Manager. In block 630, the values of AppURL and AppName are set to a null value. In one embodiment, in block 640 the first screen device waits for a first screen application (e.g., application 1 126) to begin executing on the first screen device.

In one embodiment, in block 650 the first screen device waits for the executing first screen application to call the setAppURL method of the PublishURL class or until the currently executing first screen application exits [i.e., only one first screen application executes at a time]. In block 660, it is determined whether the first screen application is executing or not. In one embodiment, there are two cases that may occur: either the setAppURL is executed by the first screen application or the first screen application exits. If it is determined that the first screen application is executing, the flowchart 600 proceeds to block 665, otherwise the flowchart 600 proceeds to block 670.

In one embodiment, in block 665, if the first screen application executes a setAppURL method, then the AppName and AppURL variables of the AppURL service are set to the first and second arguments of the setAppURL method respectively, and in block 667 a UPnP notification is sent to all second screen devices that have subscribed to the AppURL service. If the first screen application exits without having executed a setAppURL method, then in one embodiment, in block 670 if the AppName and AppURL variables of the AppURL service are null, the first screen device waits for the next first screen application to execute in block 640. Otherwise, if the first screen application exits with the AppName and AppURL variables not null, then in block 672 these variables are set to null, and in block 674 a UPnP notification is sent to all second screen devices (e.g., electronic device 140) subscribed to the AppURL service before the first screen device starts waiting for the next first screen application to execute at block 640.

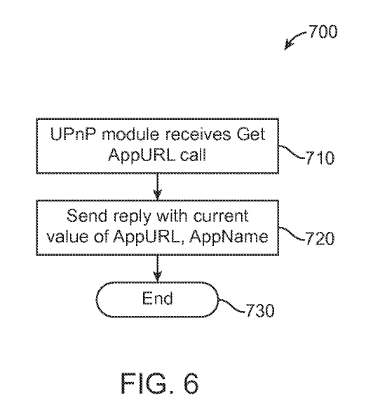

FIG. 6 shows an example flow chart 700 for a first screen device application server (e.g., AppURL server 230), according to an embodiment. In one embodiment, in block 710 the UPnP AppURL server module on the first screen device receives a GetAppURL method call from a second screen application executing on a second screen device (e.g., electronic device 140). In one embodiment, in block 720 the AppURL server sends a reply to the second screen device containing the current values of AppURL and AppName, and the flow chart ends at block 730.

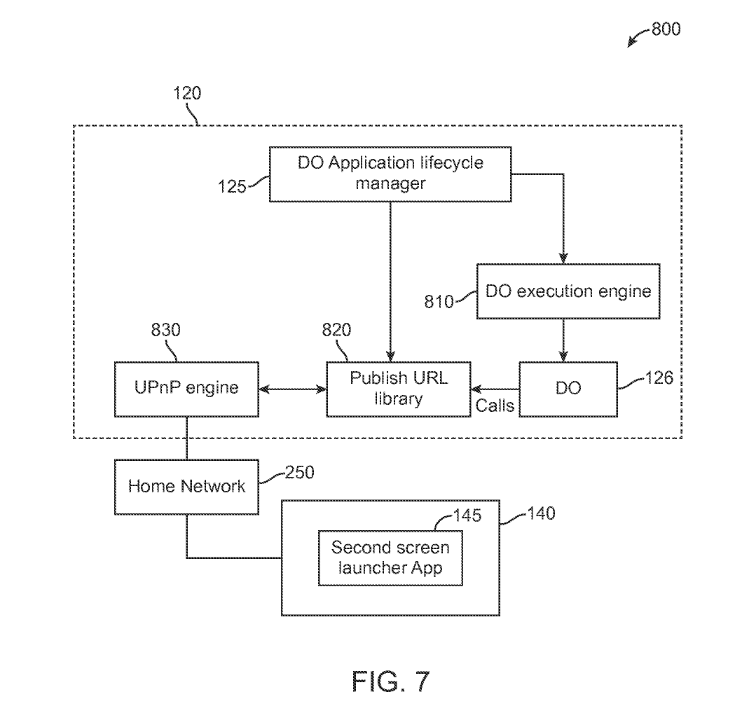

FIG. 7 shows a block diagram for an example architecture 800 for a television device 120 (e.g., a first screen device), according to an embodiment. In one embodiment, the television device comprises an application manager 125 (e.g., DO application lifecycle manager), a DO execution engine 810, a URL library publisher module 820, and a UPnP engine 830. In one embodiment, the DO execution engine 810 executes a DO application 126, which calls the URL publisher module 820. In one embodiment, the UPnP engine 830 uses the home network 250 to communicate with a second screen application launcher 145 of the electronic device 140 (e.g., a second screen device). In one embodiment, the second screen application launcher 145 launches applications, such as generic applications (e.g., remote control applications, broadcaster applications, etc.).

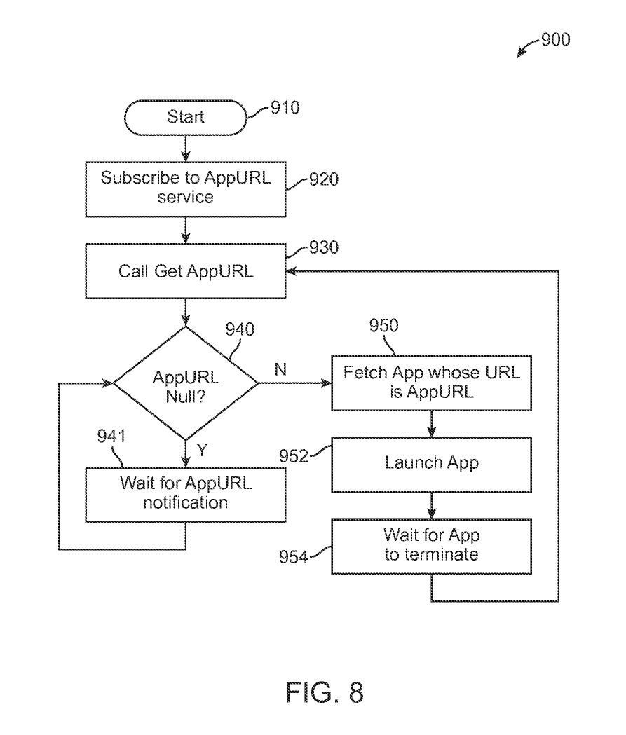

FIG. 8 shows an example flow chart 900 for an application launcher application running on a second screen device (e.g., electronic device 140), according to an embodiment. In block 910 the process begins where an AppURL service is discovered for a first screen device (e.g., television device 120). In block 920 the second screen AppLauncher application subscribes to the AppURL service on the first screen device. In one embodiment, in block 930 the AppLauncher executes a call to GetAppURL method of the AppURL service to get the AppURL and AppName of possible second screen applications.

In one embodiment, in block 940 if the AppURL value is null then in block 941 the AppLauncher waits for notification from the AppURL service on the first screen device. This notification contains the values for AppURL and AppName on the AppURL server (e.g., AppURL server 230). If the AppURL value is not null, then in block 950 the AppLauncher fetches the second screen application identified by the AppURL and AppName. In block 952 the second screen application is launched. In one embodiment, in block 954 the AppLauncher then waits for the second screen application to terminate and then returns to block 930.

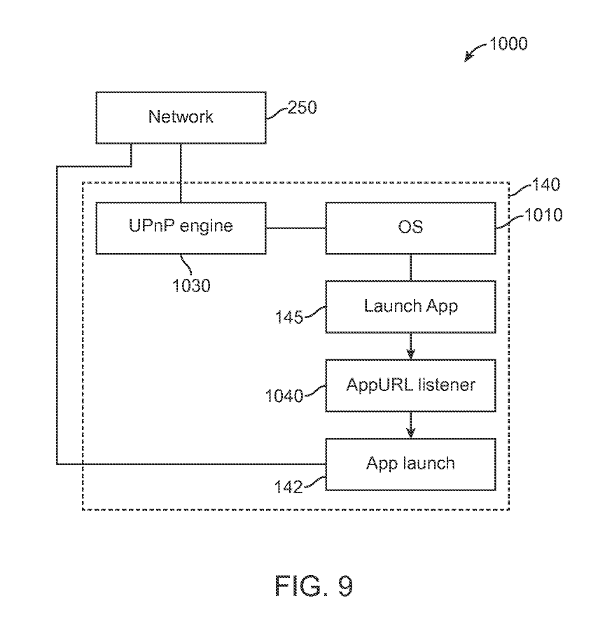

FIG. 9 shows a block diagram for an example architecture 1000 for an electronic device 120 (e.g., a second screen device), according to an embodiment. In one embodiment, the electronic device 120 is connected to the home network 250. In one embodiment, the electronic device 120 includes a UPnP engine 1030, an operating system module 1010, a launcher application 145 an AppURL listener 1040 and a second screen application 142 (e.g., a generic application, such as a remote control, broadcaster application, etc.). In one embodiment, the UPnP engine receives information that is communicated from a first screen device (e.g., television device 120) and used for launching the second screen application 142 through a process, such as shown in FIG. 8.

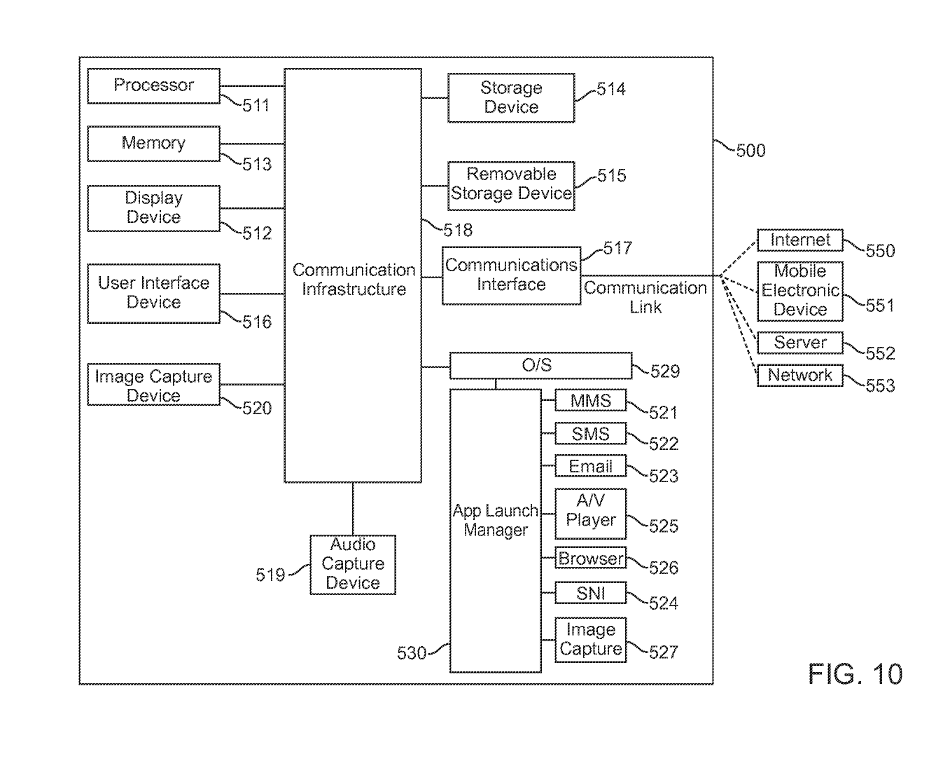

FIG. 10 is a high-level block diagram showing an information processing system comprising a computing system 500 implementing an embodiment of the present invention. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices through the Internet 550, mobile electronic device 551, a server 552, a network 553, etc. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one implementation of the invention in a mobile wireless device such as a mobile phone or tablet, the system 500 further includes an audio capture device 519 (e.g., one or more audio output devices, speakers, etc.), and an image capture device 520 such as a camera. The system 500 may further include application modules as MMS module 521, SMS module 522, email module 523, social network interface (SNI) module 524, audio/video (AV) player 525, web browser 526, image capture module 527, etc.

The system 500 further includes a discovery module 11 as described herein, according to an embodiment of the invention. In one embodiment, the system 500 includes an application launch manager 530 along with an operating system 529 that may be implemented as executable code residing in a memory of the system 500. In another embodiment, such modules are in firmware, etc.

One or more of the described embodiments may provide a convenient way for launching a second-screen application that may be a companion application to a non-triggered application (e.g., a DO) executing or that has executed on a television device in a local network (e.g., a home network). In using one or more of the described embodiments, a protocol, for example, UPnP protocol, may be used for determining when to launch a second-screen application on another electronic device other than the television device. Additionally, the second-screen device is not susceptible to persistence issues when the first-screen application terminates.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of the invention.

Though the present invention has been described with reference to certain versions thereof; however, other versions are possible. Therefore, the spirit and scope of the appended claims should not be limited to the description of the preferred versions contained herein.

What is claimed is:

1. A method for application launching for electronic devices, comprising:
executing a first application on a first electronic device based on a non-triggered input;
receiving information on a second electronic device from the first electronic device; and
launching a second application on the second electronic device based on the received information.

2. The method of claim 1, further comprising:
executing a service for the first electronic device, wherein the service provides the information received by the second electronic device.

3. The method of claim 2, further comprising:
executing a launch application on the second electronic device, wherein the launch application provides one or more of: polling the service for the information and subscribing to notifications for the information.

4. The method of claim 3, wherein the first electronic device comprises a first display, and the second electronic device comprises a second display.

5. The method of claim 4, wherein the first application provides content displayed on the first display, and the second application provides content displayed on the second display.

6. The method of claim 5, wherein the second application comprises one of a non-triggered application or a triggered application.

7. The method of claim 6, wherein the first application is received from a broadcasting system and stored on the first electronic device and comprises a non-triggered application.

8. The method of claim 6, wherein the first application is permanently stored on the first electronic device, and the non-triggered input comprises a user input.

9. The method of claim 8, wherein the first electronic device comprises a television device and the second electronic device comprises a mobile electronic device, and the information is received over a local network.

10. The method of claim 9, wherein the service notifies the launch application upon a non-triggered application executing on the first electronic device providing a URL of the second application, wherein the second application is linked to the non-triggered application.

11. A system for application launching for electronic devices, comprising:
a first electronic device that executes a first application based on a non-triggered event; and
a second electronic device that obtains information related to the first application, and executes a second application based on the obtained information.

12. The system of claim 11, wherein the first electronic device executes a service that provides the information obtained by the second electronic device.

13. The system of claim 12, wherein the second electronic device executes a launch application that provides one or more of: polling the service for the information and subscribing to notifications for the information.

14. The system of claim 13, wherein the first electronic device comprises a first display device, and the second electronic device comprises a second display device.

15. The system of claim 14, wherein the first application provides content displayed on the first display device, and the second application provides content displayed on the second display device.

16. The system of claim 15, wherein the second application comprises one of a non-triggered application or a triggered application, and the non-triggered event comprises a user launching the first application.

17. The system of claim 16, wherein the first application is received from a broadcasting system and permanently stored on the first electronic device, wherein the first application comprises a non-triggered application.

18. The system of claim 17, wherein the first electronic device comprises a television device and the second electronic device comprises a mobile electronic device, and the information is obtained over a local network.

19. The system of claim 18, wherein the service notifies the launch application upon a first-screen non-triggered application executing on the first electronic device providing a URL of the second application, wherein the second application is linked to the first-screen non-triggered application.

20. A computer program product for application launching for electronic devices, the computer program product comprising:
a tangible storage medium readable by a computer system and storing instructions for execution by the computer system for performing a method comprising:
executing a first application on a first electronic device based on a non-triggered input;
receiving information on a second electronic device from the first electronic device; and
launching a second application on the second electronic device based on the received information.

21. The computer program product of claim 20, further comprising:
executing a service for the first electronic device, wherein the service provides the information received by the second electronic device.

22. The computer program product of claim 21, further comprising:
executing a launch application on the second electronic device, wherein the launch application provides one or more of: polling the service for the information and subscribing to notifications for the information.

23. The computer program product of claim 22, wherein the first electronic device comprises a first display, and the second electronic device comprises a second display.

24. The computer program product of claim 23, wherein the first application provides content displayed on the first display, and the second application provides content displayed on the second display.

25. The computer program product of claim 24, wherein the second application comprises one of a non-triggered application or a triggered application.

26. The computer program product of claim 25, wherein the first application is received from a broadcasting system and stored on the first electronic device.

27. The computer program product of claim 26, wherein the first electronic device comprises a television device and the second electronic device comprises a mobile electronic device, and the information is received over a local network.

28. The computer program product of claim 27, wherein the service notifies the launch application upon a DO executing on the first electronic device provides a URL of the second application, wherein the second application is linked to the DO, and the non-triggered input comprises a user launching the first application.

29. A method for application launching for electronic devices, comprising:
executing a first application on a first electronic device based on a non-triggered input; and
launching, by the first application, a second application on a second electronic device, wherein the second application is related to content provided on the first electronic device.

30. The method of claim 29, wherein the first electronic device comprises a television device and the second electronic device comprises a mobile electronic device.
